(19) United States
(12) Patent Application Publication
(10) Pub. No.: US 2016/0180393 A1
(43) Pub. Date: Jun. 23, 2016

(54) RETARGETING CONSUMERS IN A PHYSICAL REALM

(71) Applicant: eBay Inc., San Jose, CA (US)

(72) Inventor: Abhijeet Vijay Mulye, Santa Clara, CA (US)

(21) Appl. No.: 14/578,351

(22) Filed: Dec. 20, 2014

(51) Int. Cl. G06Q 30/02

(52) U.S. Cl. CPC G06Q 30/0261; G06Q 30/0267

(57) ABSTRACT

Techniques for retargeting consumers in a physical realm are presented herein. In one embodiment, a method includes receiving, from a mobile computing device and based on application data stored at the mobile computing device, one or more products associated with a user of the mobile computing device, detecting the mobile computing device within a threshold range of a merchant based on a short-wavelength wireless signal from the mobile computing device, and transmitting an advertisement to the mobile computing device for one or more of the products available at the merchant.

### TECHNICAL FIELD

The subject matter disclosed herein generally relates to the technical field of marketing and sales and more specifically describes retargeting consumers in a physical realm.

### BACKGROUND

In a virtual realm, a system may install executable code, script, or similar on a user's computing device to track a user's network activity. The system may determine a user's interests based on queries, purchases, or similar. Operating as part of a retargeting network, the system may direct advertisements to the user that relate to the user's interests. Although the user may be communicating with other servers or systems, the system may continue directing advertisements to the user via the retargeting network.

In a physical realm, retargeting is more challenging. As a user physical leaves a merchant's physical location, the merchant has no lasting ability to continue advertising to the user. Furthermore, there is currently no mechanism in place for merchants to advertise to users that are physically located in other stores.

Furthermore, a system based on global positioning satellites (GPS) may not be able to effectively determine the location of a user mobile because signals from GPS satellites may not be able to penetrate through large buildings. Also, location accuracy based on GPS may not be sufficient to determine whether the user is within a merchant's physical boundary.

### BRIEF DESCRIPTION OF THE DRAWINGS

Some embodiments are illustrated by way of example and not limitation in the figures of the accompanying drawings.

FIG. 1 is a block diagram illustrating a system for retargeting consumers in a physical realm, in accordance with an example embodiment.

FIG. 2 is a block diagram illustrating a system for retargeting consumers in a physical realm, in accordance with an example embodiment.

FIG. 3 is a block diagram illustrating a system for retargeting consumers in a physical realm, in accordance with an example embodiment.

FIG. 4 is an illustration depicting one example embodiment of a system for retargeting consumers in a physical realm.

FIG. 5 is an illustration depicting one example embodiment of a system for retargeting consumers in a physical realm.

FIG. 6 is an illustration depicting one example embodiment of a system for retargeting consumers in a physical realm.

FIG. 7 is an illustration depicting one example embodiment of a system for retargeting consumers in a physical realm.

FIG. 8 is a block diagram illustrating a method for retargeting consumers in a physical realm, in accordance with an example embodiment.

FIG. 9 is a block diagram illustrating a method for retargeting consumers in a physical realm, in accordance with an example embodiment.

FIG. 10 is a block diagram illustrating a method for retargeting consumers in a physical realm, in accordance with an example embodiment.

FIG. 11 is a block diagram illustrating a method for retargeting consumers in a physical realm, in accordance with an example embodiment.

FIG. 12 is a block diagram illustrating components of a machine, according to some example embodiments, able to read instructions from a machine-readable medium and perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example systems and methods for retargeting consumers in a physical realm are described. In one embodiment, a system operating as part of a user's mobile device, may analyze local application data stored on a user's mobile device to determine one or more products that user may be interested in purchasing. The system may detect a beacon associated with a merchant. The system may then present one or more advertisements to the user of the mobile device for products that are both associated with the user and available at the merchant. In this embodiment, the various module described herein operate as part of the user's mobile device.

In another embodiment, the system may operate on a remote server. The system, in this embodiment, detects a user's mobile computing device using a beacon configured for a merchant. The system may then request and receive products associated with the user from the user's mobile computing device. The system may then determine one or more advertisements for the user that describe products available at the merchant, and may transmit one or more advertisements to the user's mobile computing device. Of course, many other example embodiments are described herein. In certain embodiments, the various modules and/or functions of the various modules may be performed either on the mobile computing device of the user or a remote system. The various embodiments and examples are described in subsequent paragraphs.

In one example embodiment, as a user enters a merchant's physical store, the user may then receive advertisements advertising sales, coupons, discounted items, or other products that the user may had previously searched for. For example, if the user had been looking for a red sweater (based on previous network activity and/or application data stored on the user's mobile device), in response to the system detecting the user's mobile device, the merchant may transmit an advertisement for red sweaters. Such a targeted advertisement may be more effective in motivating the user to purchase.

In another example embodiment, the range of the beacon may extend to cover a competitor for the merchant. Therefore, in response to the user enter the competitors store, the merchant may detect the user and transmit advertisements to the user to lure the user away from the competitor and motivate the user to go to the merchant's physical store.

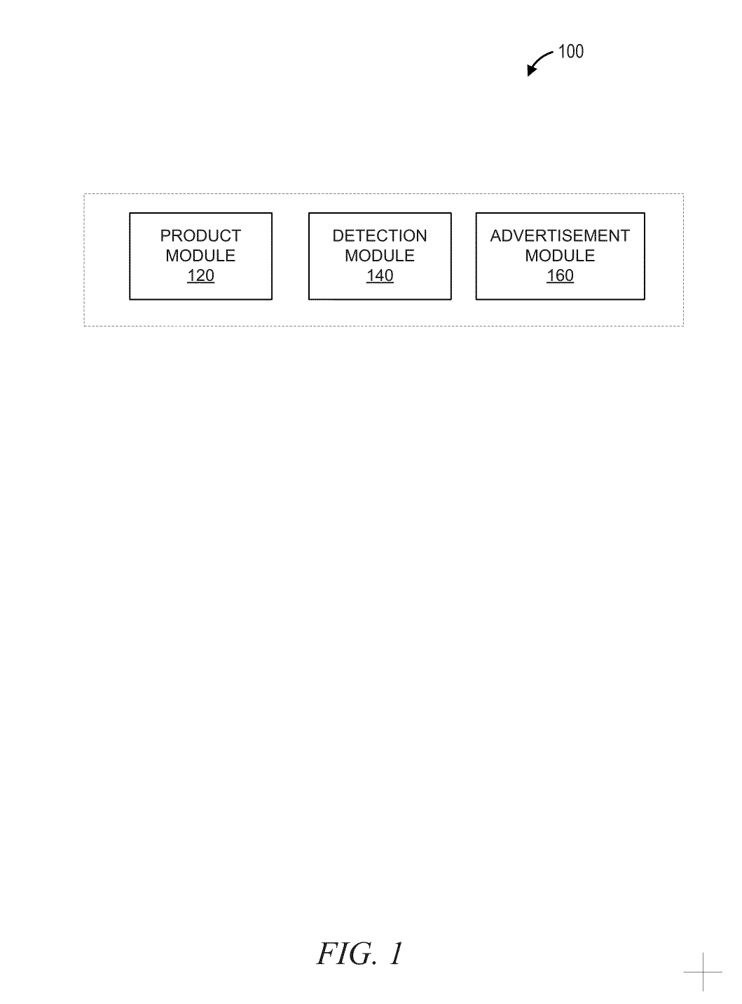

FIG. 1 is a block diagram illustrating a device 100 for retargeting consumers in a physical realm, in accordance with an example embodiment. According to one example embodiment, the device 100 includes a product module 120, a detection module 140, and an advertisement module 160. As previously described, in some embodiments, the device 100 may operate as part of a user's mobile computing device, whereas, in other embodiments, the device 100 operates as a remote system communicating with a user's mobile computing device over a network.

In one embodiment, the product module 120 may be configured to determine one or more products associated with a user. The product module 120 associates a product with the user based on various conditions of a user or group of users as will be described in the following paragraphs. Thus, each association made by the product module 120 may be in the form of a condition and a resulting association. The following examples illustrate where conditions are identified and associations are made.

In one example, a condition is application data stored on the user's mobile computing device including one or more products. The product module 120, operating as part of a user's mobile computing device, may examine application data stored at a mobile device associated with the user. For example, the product module 120 may read a browser application search history to determine products the user has searched for. In another example, the product module 120 may read application data associated with an online seller of goods and/or services.

In a specific non-limiting example, a user may be searching for an umbrella and may enter a search term “umbrella” in an Internet browser. In another example, the user may search for an umbrella at an online retailer, a networked marketplace, or other, or the like. Based on the user looking for an umbrella, the Internet browser may store the search in the browser's application data. Based on this condition being met, the product module 120 may associate an umbrella item with the user.

In another example embodiment, the product module 120 may operate as part of a remote server. A condition may include the product module 120 receiving one or more products from the mobile computing device to associate with the user. For example, an application executing on the mobile device may examine application data to determine associated products as described herein and may transmit the products to the product module 120. A mobile computing device at least includes a computing device transportable by a person. In certain examples, the mobile computing device is selected from the group consisting of a cellular device, a tablet, a laptop, a wearable computing device, or other movable computing device, or the like, as one skilled in the art may appreciate.

In another example embodiment, a condition includes the application data storing search queries by the user for a networked marketplace. A networked marketplace may include a system that allows users to purchase and/or sell products and/or services over a network. A local application executing on the mobile device for the user may store the various searches performed by the user in application data. The product module 120 may examine the application data and determine a product the user is interested in purchasing based on the user searching for the product and/or service via the networked marketplace.

In certain embodiments, the product module 120, operating as part of a user's mobile computing device, may examine any and/or all data stored on the mobile computing device and may associate the user with products discovered in the data. For example, the product module 120 may perform string matching on all data stored on the mobile device.

The product module 120 may further associate the user with products that are related to products discovered in the application data. For example, in response to the user searching for a wedding ring, the product module 120 may also associate related items, such as, but not limited to, wedding gifts, tuxedos, wedding dresses, other jewelry, flowers, or other items or services, or the like.

In another example embodiment, a condition may include the application data storing indicators that the user has purchased tickets to attend an event. In response, the product module 120 may associate the user with products that are related to the special event.

In one non-limiting example, the product module 120 may determine that the user has purchased tickets to a football game. The product module 120 may associate products that are related to a football game with the user. For example, the product module 120 may associate paraphernalia for a team participating in the football game, concessions, tickets for other games, or the like. Therefore, although a user may not have specifically searched for team paraphernalia, the product module 120 may nevertheless associate user with a product relating to the football game.

In another example embodiment, the product module 120 may store a list of applications that include product related data. The product module 120 may include formatting information so as to facilitate accurate data acquisition from the application. Knowledge of how data is stored in application data may increase accuracy and speed of discovering products and/or services associated with the user.

In one example embodiment, the product module 120 may receive a list of applications that include relevant application data. The product module 120 may also receive application data formatting and the location of application data. This may limit the amount of time the product module 120 searches for products to associate with the user. In one example embodiment, the product module 120 may receive an updated list at regular intervals, or other intervals. For example, the product module 120 may receive a list of applications daily, weekly, monthly, or other interval, or the like. Of course, other time intervals may be used and this disclosure is not limited in this regard.

In another example embodiment, a condition may include any computing device associated with the user storing product information in application data. For example, where a user communicates with the product module 120 using different devices, the product module 120 may associate both devices with the user. Therefore, in certain embodiments, the product module 120 may associate products with the user based on application data stored at either of the associated devices. For example, a user may search for one or more products at the networked marketplace via a home computing device. The product module 120 may associate the products with the user and the association may also include the user's mobile computing device, or other devices used by the user.

In another embodiment, two or more devices may be associated with a single mobile device plan. For example, a parent may include mobile devices for children of the parent. The product module 120 may associate products based on application data stored on a child's mobile device and may associated the products with the parent user.

In another example embodiment, the product module 120 a condition may include a user searching for and/or purchasing similar products at regular intervals. For example, in response to a user searching for different brands of shoes on a daily basis, the product module 120 may associate the user with shoes in general. In another example, in response to a specific user purchasing sporting goods on a regular basis, the product module 120 may associate products that are sporting goods with the user. Therefore, the product module 120 may associate a class of products with the user although the user may or may not have actually expressed interested in a specific product belonging to the class of products.

Therefore, in certain embodiments, the product module 120 may associate the user with a broader category of items based, at least in part, on one or more products that the user has demonstrated interest in. In another example, the user may purchase electronics on a consistent basis such as for example, weekly, monthly, yearly, or the like. In response, the product module 120 may associate the user with a general category of electronics.

In another example, the product module 120 may associate the user with a product based on the location of the user. In one example, the system 100 may determine that the user is located in a specific department of a retail outlet, the product module 120 may associate the user with the types of products available in that specific department. For example, in response to the user being in a camping section of a store, the product module 120 may associate the user with camping equipment general, or a camping category. In another specific example, the user may be given a sweater area of a regional outlet. In response, the product module 120 may associate user with sweaters. Of course, the product module may associate the user with other products based, at least in part, on the location of the user and this disclosure is not limited in this regard.

In one example embodiment, the detection module 140 may be configured to detect a mobile device for the user within a threshold distance of a merchant based on a short wavelength wireless signal received from the mobile device. For example, at the merchant's physical location, the detection module 140 may periodically transmit a short wavelength wireless signal that requests connections according to a wireless communication protocol (e.g. Bluetooth™). A user's mobile device may be configured to respond to the detection module 140 according to the protocol. Based on the response, the detection module 140 may determine that the user's mobile computing device is within the threshold range of the merchant.

In another example embodiment, the detection module 140 may be configured to detect a beacon operating at a merchant by receiving a wireless signal from the beacon. Because the beacon is configured to transmit a low power wireless signal, the detection module 140 may determine that it is within a threshold distance of the beacon based, at least in part, on the power level of the wireless signal. Of course, one skilled in the art may recognize how different power levels may change the threshold distance and this disclosure is mean to include all such local short-wave wireless signals. In this embodiment, a beacon for a merchant may be configured to periodically transmit a short wavelength wireless signal. In response, the detection model 140 may determine a location of the beacon by either receiving the location from the beacon or retrieving beacon location information for the beacon from a remote system. Based on the determined location, the detection module 140 may determine that the mobile computing device is within a threshold range of the merchant.

In one example, the detection module 140 may have information regarding beacon locations. In response to the beacon identifying itself such as through an identifier or other mechanism, the detection module 140 may determine the location of the beacon based on information. In another example the detection module 140 may receive location from the beacon. Of course, one skilled in the art may recognize other ways in which the detection module 140 may determine a location based on a signal from a beacon at a merchant's physical location and this disclosure is meant to include all such ways.

In one specific example, the beacon may transmit a Bluetooth™ wireless signal. The detection module 140 may be configured to pair with the beacon using the Bluetooth™ communication protocol. In another specific example, the beacon may transmit a near field communication (NFC) signal that the detection module 140 may similarly respond according to a communication protocol for NFC as one skilled in the art may appreciate.

In another example embodiment, the detection module 140 may periodically transmit a Bluetooth™ wireless signal to detect user's mobile devices. A user's mobile device may be configured to respond to a Bluetooth™ connection request. Based on a response from the user's mobile device, the detection module 140 may determine the users mobile computing device is within a threshold range of the merchant's physical location.

In one example embodiment, the beacon may be configured such that a range of the short wavelength wireless signal extends to physical boundaries of the merchant's physical location. In this way, the detection module 140 may determine that the user's mobile device is within a merchants physical location based on the users mobile device being in communication range with the beacon. Therefore, the detection module may determine that a user is located within a merchant's physical location based on the user's mobile computing device communicating with the merchants beacon.

In another example embodiment, a range or the beacon may be configured to extend into physical boundaries of a competitor. Therefore, the detection module 140 may determine that a user is located within a competitor's physical location. According to one specific example, the detection module 140 may detect users entering a competitor's store, or may detect users in a specific department of the competitor's physical store.

In another example embodiment, the detection module 140 may similarly detect many mobile computing devices. The detection module 140 may determine a class of the users of the many mobile computing devices based on information associated with the users. In one example, each user may have a user profile for the networked marketplace and the detection module 140 may inspect the profile data for each user to determine a gender for each user. Other examples include the detection module determining an age for the users, a race for the users, a religion for the users, or other attributes, or the like.

In one example embodiment, the detection module 140 may determine that the many users include children. In response, the detection module 160 may notify the advertisement module 160 that there are many children in the area. In another example, the detection module 160 may read users profile information to determine that there are many elderly people, many Hispanics, many Mormons, or other, or other, or the like. The detection module 140 may notify the advertisement module regarding a type or class of users that are within a local communication range of the merchant's beacon.

In another example embodiment, the detection module 140 may detect mobile devices for a number of users associated with a specific product. For example, a threshold value may be 20, and the detection module 140 may notify the advertisement module 160 in response to detecting more than 20 users interested in a specific product.

In one specific example, the product module 120 may determine a set of users who will be attending a football game in the area. For example, the product module 120 may inspect application data on mobile devices associated with the users to determine that the users have purchased tickets to the football game. The product module 120 may associate users with mobile devices based on the users authenticating with the product module 120 via their respective mobile devices.

After determining the mobile devices that are within a threshold range of a merchant, the detection module 140 may then notify the merchant that the set of users is in the merchant's store. In response, the merchant may provide an advertisement to the advertisement module 160, and the advertisement module 160 transmits the advertisement to the mobile devices. For example, the mobile devices may be configured to receive advertisements from the advertisement module 160.

In one example embodiment, the advertisement module 160 may be configured to transmit an advertisement to a mobile computing device. The advertisement may include any media as one skilled in the art may appreciate. In certain examples the advertisement includes a text message, an image, audio signal, a video signal, a combination thereof, or other, or the like. This disclosure is not limited regarding type of media advertising.

In another example, the advertisement module 160 may transmit many advertisements to the user's mobile device. For example in response to the product module 120 determining a set of products to associate user, the advertisement module 160 may transmit any and/or all advertisements for associated products. In another example embodiment, the advertisement module 160 may determine an advertisement to transmit to the user's mobile device based, at least in part, on products associated with the user.

In one example embodiment, the advertisement module 160 may receive one or more advertisements for an associated product. In another embodiment, the module 160 may present a received advertisement via a display device. In another example, the advertisement module 160 may receive multiple advertisements or one or more associated products. The advertisement module 160 may display any and/or all advertisements received.

In one example the advertisement may include a text message and the advertisement module 160 may display the text message. In response to the advertisement including image, the advertisement module 160 may display the image. Based on the advertisement including audio and/or video, the advertisement module 160 may play the audio and/or video. Of course one skilled in the art may appreciate other ways in which media content may be presented to a user this disclosure is meant to include all such ways.

In another example embodiment, in response to the detection module 140 detecting multiple mobile devices where users are in a class of users, the advertisement module 160 may request an advertisement from a merchant that provides products that are associated with one or more of the users.

For example, in response to determining that many children are in the merchant's physical store, the advertisement module 160 may request that the merchant provide an incentive related to children. For example, the merchant may offer a discounted price for toys. In another example, in response to detecting a class of users that are sports fans, the advertisement module 160 may notify the merchant that the current set of users in the merchants store would more likely be interested in sporting goods due to many users being associated with sporting based products.

The advertisement module 160 may notify the user that an advertisement has been received in a wide variety of different ways. For example, the advertisement module 160 may cause the a mobile device to play an audible notification, beep, vibrate, flash a light, or other, or the like. Of course, one skilled in the art may appreciate other ways to notify a user regarding reception of media content and this disclosure is meant to include all such ways.

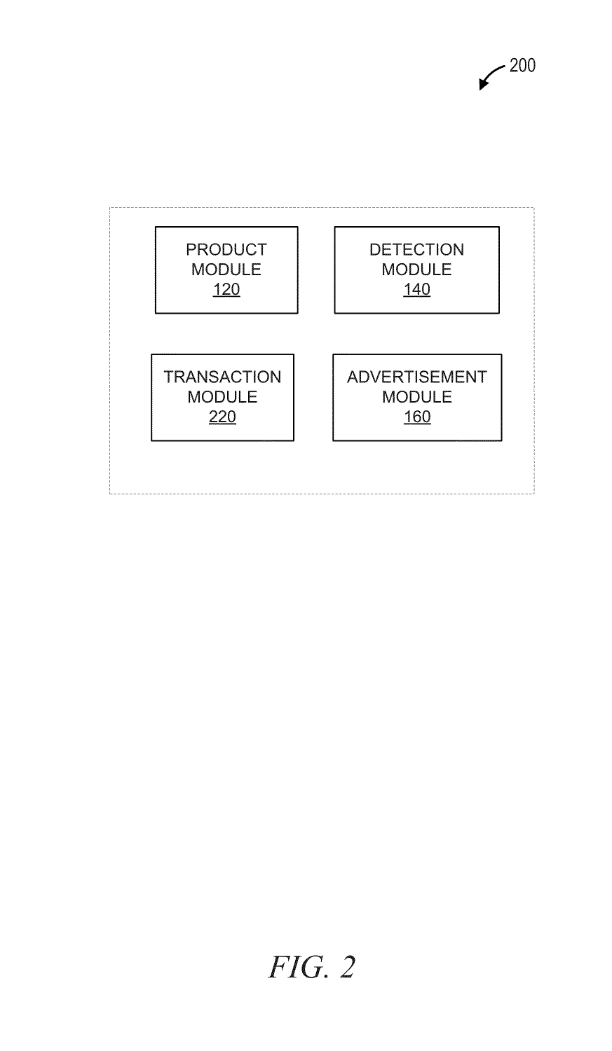

FIG. 2 is a block diagram illustrating a system for retargeting consumers in a physical realm, in accordance with an example embodiment. In one example embodiment, the system 200 includes the product module 120, the detection module 140, the advertisement module 160, and a transaction module 220. The product module 120, the detection module 140 and the advertisement module 160 may or may not be substantially similar to those depicted in FIG. 1.

In one example embodiment, the transaction module 220 may be configured to receive a request from a user of a mobile computing device to purchase an advertised product. The transaction module 220 may receive the request from the user's mobile device via a short wavelength wireless signal. For example, the transaction module 220 may receive the request via the beacon. In another example, the transaction module 220 may receive the request over a wide area wireless network, such as, but not limited to, a cellular network, or other, or the like. For example, the user's mobile device may transmit the request over a data connection with a cellular service provider, and the transaction module 220 may receive the request over the Internet, or other network, or the like. In another example embodiment, the transaction module 220 may inquire of the user whether the user would like to purchase an advertised product.

In certain embodiments, a short wavelength wireless signal may include a signal with a frequency of between 2400 and 2483.5 MHz. Of course, other frequency ranges may be used and this disclosure is not limited in this regard. Furthermore, the short wavelength wireless signal may be limited to 100 milliwatts as one skilled in the art may appreciate; however, this is not necessarily the case. One skilled in the art may configure other frequencies and/or power levels in order to adjust a range for a wireless beacon as described herein.

In another example embodiment, the transaction module 220 may receive financial information from a user and may perform a financial transaction between the user and the merchant. For example, in response to the user indicating desire to purchase the advertised product, the transaction module 220 may request financial necessary to perform a financial transaction, and may transfer funds from the user to the merchant.

In one example embodiment, the transaction module 220 may notify the merchant that the user has purchased a product. The merchant may then prepare the product for pick-up by the user. In order to provide additional security, the request to purchase the product may include an image of the user. In this example, the merchant may verify the identity of the user making the purchase. In one example embodiment, the transaction module 220 may store user images and/or other financial information received from a user so that the user need not provide the financial information for a subsequent purchase.

In one example embodiment, the transaction module 220 may transmit a request to purchase an advertised product from a user's mobile computing device. As previously described, the transaction module 220 may include an image or photograph of the user so that the merchant may verify that the user is the correct owner of the mobile computing device.

In another example embodiment, the transaction module 220 may deny a request to purchase an advertised product in response to the detection module 140 determining that the user's mobile computing device is not within a threshold range of a beacon for a merchant.

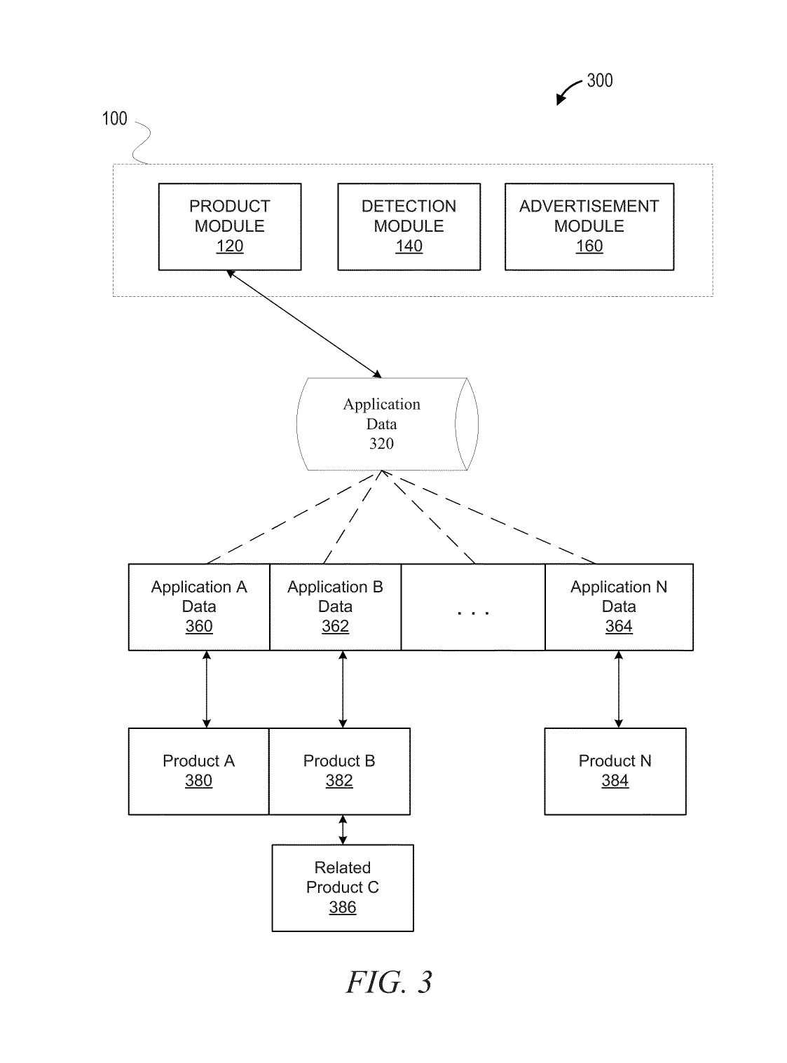

FIG. 3 is a block diagram illustrating a system for retargeting consumers in a physical realm, in accordance with an example embodiment. In one example embodiment, the system 100 may operate as part of a user's mobile computing device. According to this embodiment, the product module 120 may inspect application data 220 stored on the user's mobile computing device.

In one example embodiment, the application data 320 may be stored on a non-volatile storage medium as one skilled in the art may appreciate. The product module 120 may read the application data from the storage device. According to one embodiment, the application data 320 may store Application A data 360, Application B Data 362, Application N Data 364, and others. Although four Applications are depicted in FIG. 3, this disclosure is not limited in this regard. Furthermore, although Application N Data 364 is depicted as the last application, the letter ‘N’ may represent any number. Therefore, the application data 320 may store data for any number of applications on the user's mobile computing device.

The product module 120 may read Application A Data 360 and determine that the user is associated with a product A identified in the Application A Data 360. In one example, Application A may include StubHub™ and the product module 120 may determine that the user has purchase tickets to a football game. Therefore, the product module 120 may associate football products with the user, such as, but not limited to, footballs, hats, fan paraphernalia, or other related products.

In another example, Application B Data 362 may be an Amazon™ application, and the product module 120 may read the Application Data 362 to determine products the user has purchased or has searched for on Amazon™, for example, Product B 382. In response, the product module 120 may associate the user with Product B 382. In a further example, the product module 120 may associate the user with a product that is associated with Product B 382. For example, where Product C 386 is related to Product B, the product module 120 may also associate Product C with the user.

In one example embodiment, Application B Data 362 may include a merchant that sells board games. In response to the user buying one board game (e.g. Product B 382), the product module 120 may also associate another board game (e.g. Product C 386).

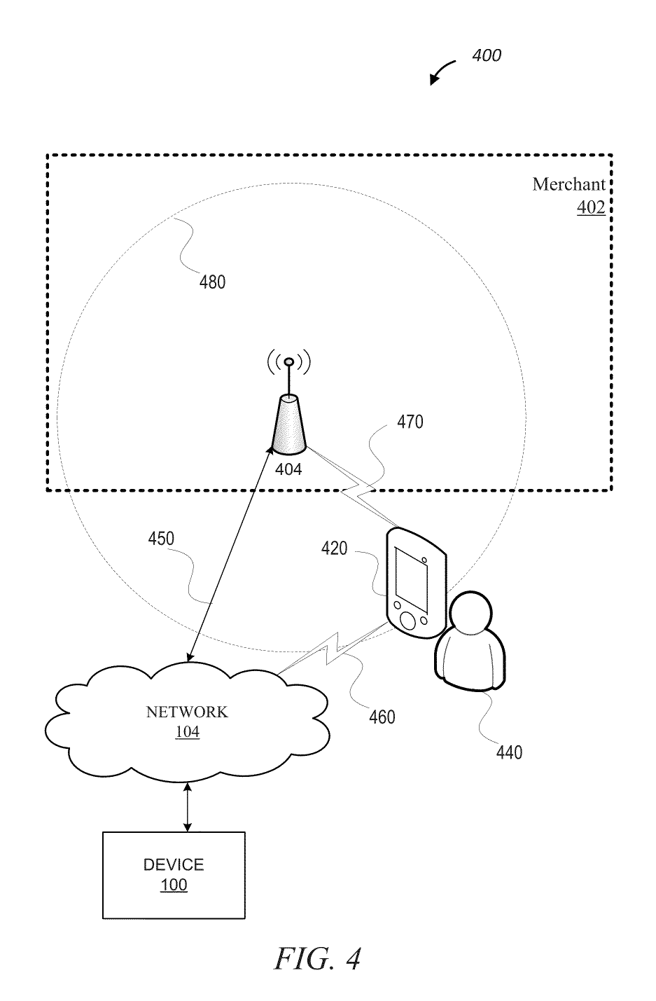

FIG. 4 is an illustration depicting one example embodiment of a system for retargeting consumers in a physical realm. According to this embodiment, a merchant 402 may include a beacon 404 that transmits a short wavelength wireless signal capable of reaching a range 480 as indicated in FIG. 4.

In one example embodiment, a range 480 of the wireless beacon 404 may extend beyond the physical boundaries of the merchant 402. In one example, a user 440 may travel so that the user's mobile computing device 420 is within a threshold range 480 of the beacon 404. In response, the detection module 120 may detect the user's 440 mobile computing device 420 as previously described.

In one example embodiment, the user's 440 mobile computing device 420 may be configured to identify one or more products associated with the user 440 and transmit the products over a network 104 to the product module 120. The network 104 may be any type of network as one skilled in the art may appreciate and this disclosure is not limited to the type of network used. In one specific example, the network 104 may be the Internet.

In another example embodiment, the beacon 404 may notify the detection module 140 that the user's mobile computing device 420 is within a threshold range (of the beacon). Therefore, according to one embodiment, detecting that the user's mobile computing device is within a threshold range of the beacon 404 may be based on a short wavelength wireless signal 470 from the mobile computing device by the beacon 404. The beacon 404 may communicate with the detection module 140 over the connection 450 with the network 104 as one skilled in the art may appreciate.

In another example embodiment, the advertisement module 160 may determine an advertisement to transmit to the user's mobile computing device 420. In one example embodiment, the advertisement module 160 may transmit many advertisements to the user's mobile computing device 420 and the user's mobile computing device 460 may select one or more of the advertisements to display to the user 440 based, at least in part, on products associated with the user. In another embodiment, the advertisement module 160 may prioritize advertisements. For example, the advertisement module 160 may include a higher priority for video advertisements than image based advertisements. Therefore, in response to receiving multiple advertisements describing a product associated with the user, the advertisement module 160 may present the video and not the image.

In one example, the advertisement module 160 may transmit the advertisements over a wireless network connection 460 via the Network 104. In another example, the advertisement module 160 may transmit the advertisements to the beacon 404 to be forwarded to the user's mobile computing device 420 over the short wavelength wireless communication medium 470. Of course, one skilled in the art may recognize other ways to transmit advertisements to the user's mobile computing device and this disclosure is not limited in this regard.

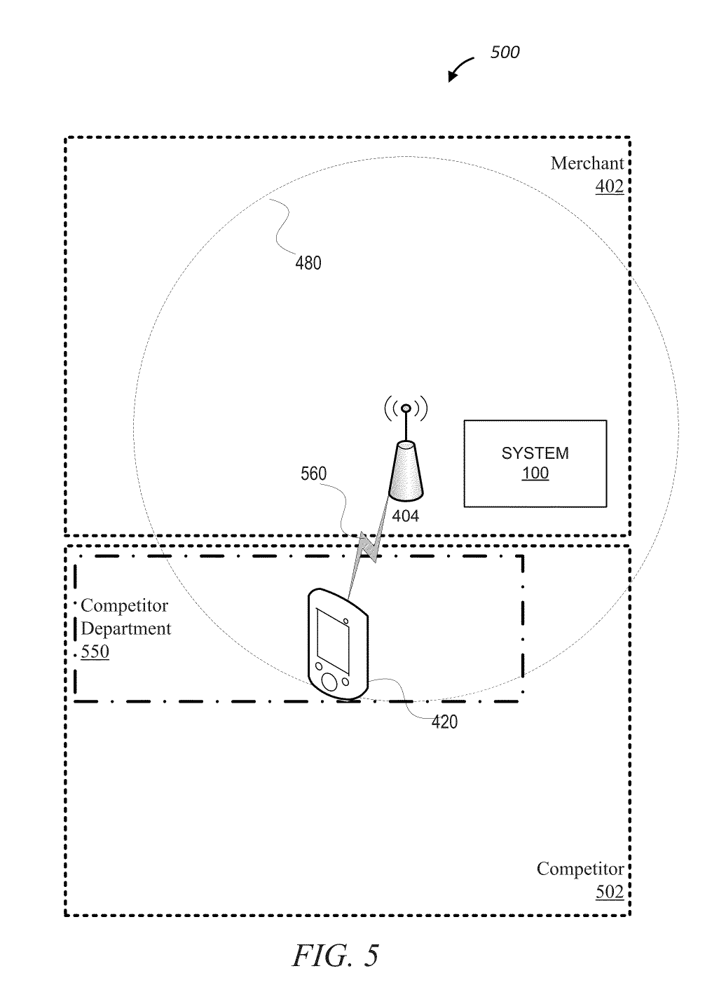

FIG. 5 is an illustration depicting one example embodiment of a system for retargeting consumers in a physical realm. According to this example embodiment, a merchant 402 and a competitor 502 may be located nearby each other. The merchant 402 may configure a beacon 404 so a range 480 of the beacon not only covers the merchant's 402 physical location, but also extends into a competitor's 502 physical location.

In one example embodiment, a user's mobile computing device 420 may be located at a competitor's 502 physical location. Furthermore, the user's mobile computing device 420 may be located in a specific department 550 of the competitor's 502 physical location. In this example, the user's mobile computing device 420 may not be detected in the merchant's physical location 402 based, at least in part, on a beacon a previously described. The detection module 140 may detect the user's mobile computing device 420 based on communications with the beacon 404. Because the user's mobile computing device 420 is not detected in the merchant's physical location 402, but is detected by the detection module 140, the detection module 140 determines that the user's mobile computing device is located in the department 550 of the competitor's physical location 502.

In response to the detection module 140 determining that the user's mobile computing device 420 is located in the competitor's department 550, the product module 120 may associate the user with the types of products available in the department 550. For example, the department 550 may be a shoes department 550 of the competitor 502. In response to the detection module 140 detecting the user's mobile computing device 420 in the competitor's department 550, the advertisement module 160 may transmit one or more advertisements to the user's mobile computing device 420 to advertise products available at the merchant's 402 physical location that are of the type of product available in the competitor's department 550.

For example, where the department 550 is for shoes, the advertisement module 160 may transmit advertisements that advertise shoes available at the merchant's 402 physical location while the user is in the competitor's shoe department 550. Accordingly, the system 100 may effectively retarget the user of the mobile computing device 420 to the physical location of the merchant 402.

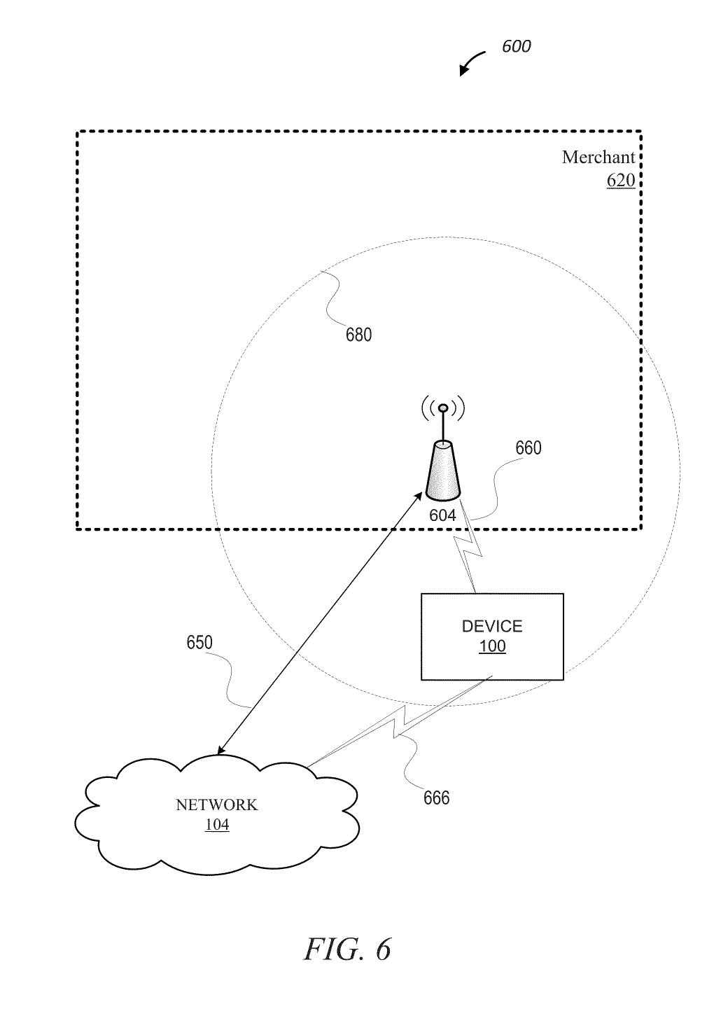

FIG. 6 is an illustration depicting one example embodiment of a system 600 for retargeting consumers in a physical realm. In one example embodiment, a merchant 620 may include a beacon 604 that transmits a local short wavelength wireless signal 660 detectable within a threshold range 680.

The system 100, in this example embodiment, may be the user's mobile computing device. The product module 120, operating as part of the system 100 may inspect local application data to determine one or more products associated with the user of the system 100.

The detection module 140, in this example embodiment, detects the short wavelength wireless signal 660 from the beacon 604. The detection module 140 may access information regarding the location of the beacon over the communication medium 666, and determine a location from a remote system. In another example embodiment, the detection module 140 may determine the merchant 620 based on the location of the beacon. For example, the detection module 140 may request a location of the beacon 604 from a remote server via the connection 666 reachable via the Network 104.

In another example embodiment, the beacon 604 may identify its location and/or an associated merchant 620 so that the detection module 140 may determine the location and/or the merchant 620. In response, the advertisement module 160 may receive one or more advertisements via the connection 666 from a remote advertising server operating as part of the Network 104. The advertisement module 160 may determine an advertisement to display based on an advertisement describing an associated product available at the merchant 620. In another example embodiment, a remote advertising system may transmit one or more advertisements to the beacon 604 via the connection 650. Accordingly, the advertisement module 160 may receive an advertisement from the merchant's 620 beacon 604 and may present the advertisement.

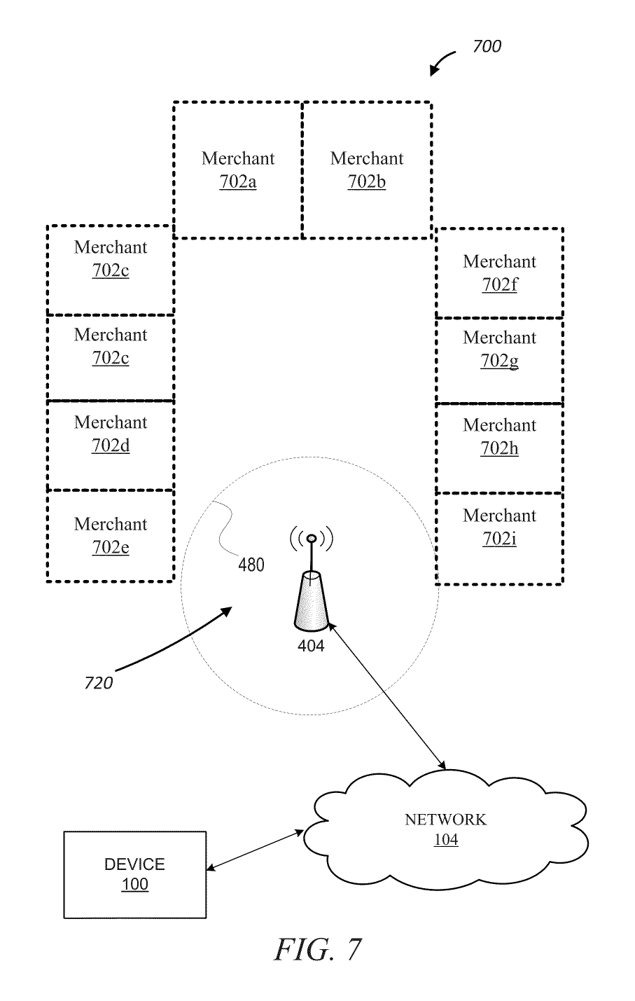

FIG. 7 is an illustration depicting one example embodiment of a system 700 for retargeting consumers in a physical realm. In one example embodiment, many merchants 702 may be associated with a beacon 404 transmitting a short wavelength wireless signal up to a threshold distance 480. The beacon 404 may or may not be substantially similar to beacons presented in FIG. 4-6.

In one example, the merchants 702 may be at a mall and the beacon 404 may be configured to cover an entrance 720 to the mall. The beacon 404 may be further configured to report to the detection module 140 when user's mobile devices pass through the entrance 720 to the mall. In response, the detection module 160 may determine that the user's mobile devices are within a threshold range of the merchants 702.

The product module 120 may determine a class of users present in the mall based, at least in part, on the detected mobile devices. The advertisement module 160 may, in response, notify any and/or all of the merchants 702 regarding the class of users in the mall. In another example embodiment, the product module 120 may determine two or more classes of users current present in the mall. The advertisement module 160 may transmit advertisements to mobile computing devices that describe products available at any of the merchants 702. Therefore, in certain embodiments, a user may enter a mall, and immediately receive advertisements for products available at the mall that the user has demonstrated interest in.

In one example embodiment, merchants 702a, 702b, and 702c may be affiliated with the system 100. Other merchants 702d-i, may not be affiliated with the system 100. Accordingly, the advertisement module 160 may transmit advertisements for the affiliated merchants, but not the unaffiliated merchants.

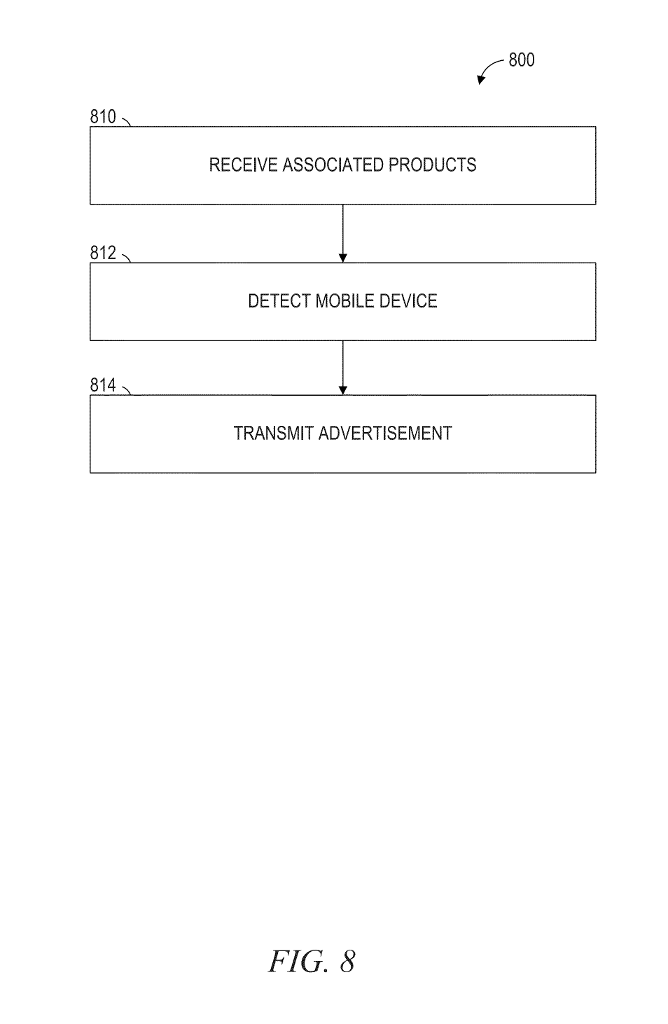

FIG. 8 is a block diagram illustrating a method 800 for retargeting consumers in a physical realm, in accordance with an example embodiment. Operations in the method 800 may be performed by the system 100, using modules described above with respect to FIGS. 1-2. As shown in FIG. 8, the method 800 includes operations 810, 812, 814. In this embodiment, the system 100 may substantially operate as a server either accessible via the Network 104, or at a merchant as described herein.

In one embodiment, the method 800 may begin and at operation 810 the product module 120 may receive one or more products associated with a user of a remote mobile computing device. The associated products may be based on application data stored on the mobile computing device.

The method 800 may continue at operation 812 and the detection module 140 may detect the mobile computing device within a threshold range of a beacon affiliated with a merchant based on a short wavelength wireless signal from the mobile computing device. For example, a beacon 404 may detect a user's mobile computing device and notify the detection module 140. The method may continue at operation 814 and the advertisement module 160 may transmit an advertisement to the mobile computing device.

The advertisement module 160 may transmit the advertisement to the mobile computing device either through the Network 104, via the beacon 404, or through other means as one skilled in the art may appreciate. Furthermore, the advertisement module 160 may and and/or all advertisements for products available at the merchant and the mobile computing device 420 may select certain advertisements to display. In another example embodiment, the advertisement module 160 may select an advertisement to transmit based on similarities between available advertisements and products associated with a user for the mobile computing device.

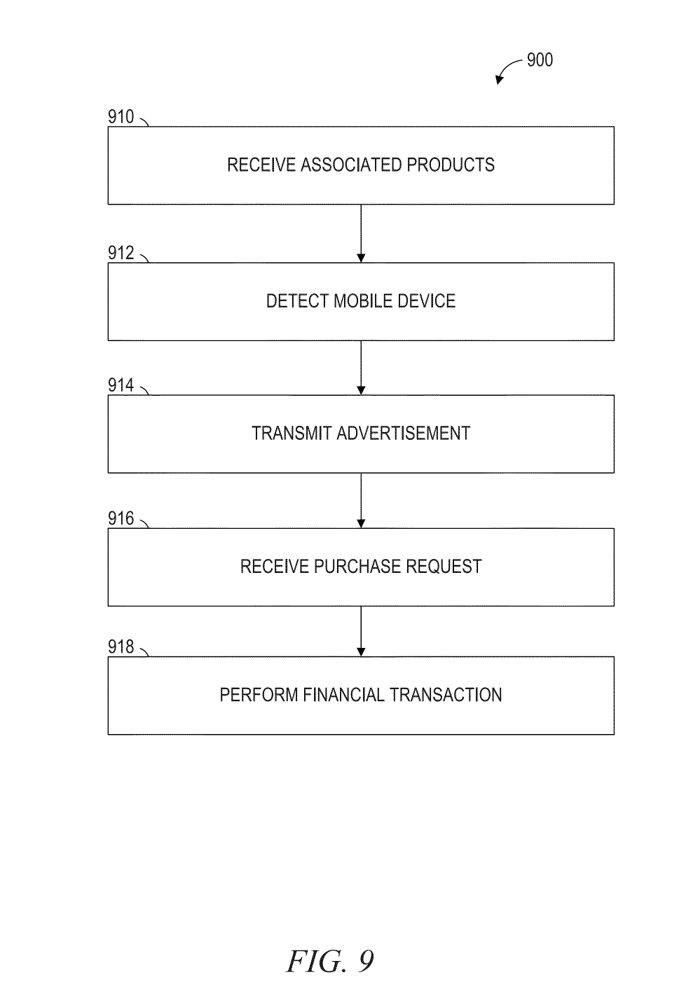

FIG. 9 is a block diagram illustrating a method 900 for retargeting consumers in a physical realm, in accordance with an example embodiment. Operations in the method 900 may be performed by the system 100, using modules described above with respect to FIGS. 1-2. As shown in FIG. 9, the method 900 includes operations 910, 912, 914, 916, and 918.

The method 900 may begin at operation 910 and the product module 120 may receive one or more products to be associated with a user 440 of a mobile computing device. The detection module 140 may detect the mobile computing device 420 within a threshold range of a merchant based, at least in part, on a short wavelength wireless signal from the mobile computing device 420. For example, a beacon 404 at the merchant may periodically transmit a short wavelength wireless signal. Based on responses received from a mobile computing device 420 within a threshold range of the beacon 404, method 900 may continue at operation 912 and the detection module 140 may detect the mobile computing device 420.

In response to detecting the mobile computing device, the method may continue at operation 914 and the advertisement module 160 may transmit one or more advertisements to the mobile computing device. The advertisements describe products available at the merchant that are associated with a user of the mobile computing device. The method 900 may continue at operation 916 and the transaction module 220 may then receive a request to purchase a product described in one of the advertisements. The method 900 may continue at operation 918 and the transaction module 220 performs a financial transaction between the user of the mobile computing device and the merchant.

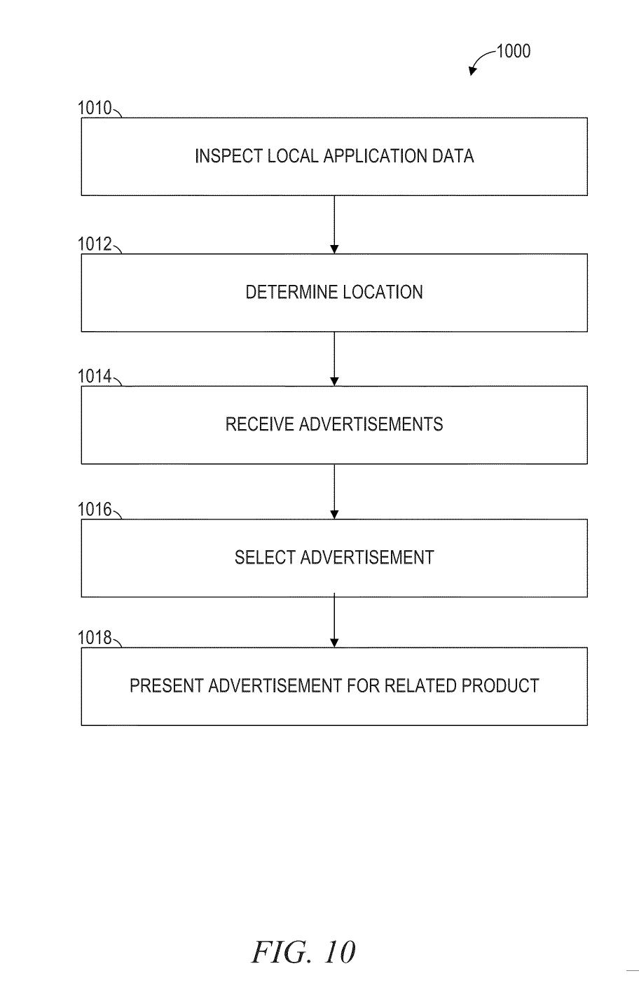

FIG. 10 is a block diagram illustrating a method 1000 for retargeting consumers in a physical realm, in accordance with an example embodiment. Operations in the method 1000 may be performed by the system 100, using module described above with respect to FIG. 1-3. As shown in FIG. 10, the method 1000 includes operations 1010, 1012, 1014, 1016, and 1018.

The method 1000 may begin at operation 1010 and the product module 120 may inspect local application data stored on the mobile computing device to determine one or more products to associate with a user of the mobile computing device. The method 1000 may continue at operation 1012 and the detection module 140 may detect a short wavelength wireless signal from a beacon for a merchant, and may determine that the mobile computing device is within a threshold range of the merchant.

The method 1000 may continue at operation 1014 and the advertisement module 160 may receive one or more advertisement describing products that are available at the merchant. The method 1000 may continue at operation 1016 and the advertisement module 160 may select an advertisement to present based on an advertisement describing a product that is associated with the user. The advertisement module 160 may then present, at operation 1018, the selected advertisement.

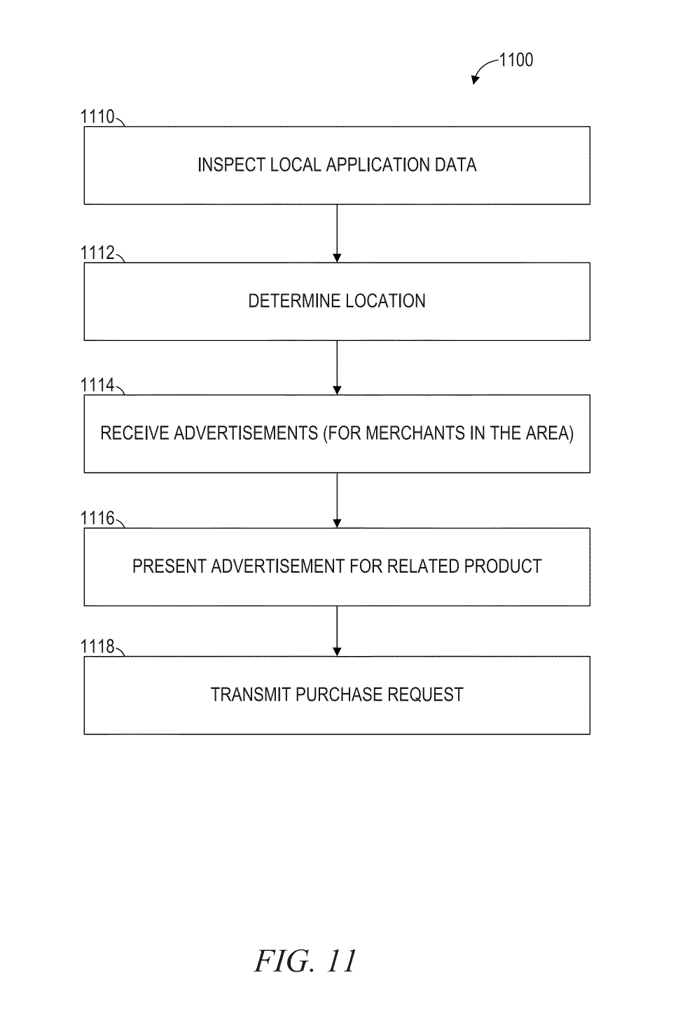

FIG. 11 is a block diagram illustrating a method 1100 for retargeting consumers in a physical realm, in accordance with an example embodiment. Operations in the method 1100 may be performed by the system 100, using modules described above with respect to FIG. 1-3. As shown in FIG. 11, the method 1100 includes operations 1110, 1112, 1114, 1116, and 1118.

The method 1100 may begin at operation 1110 and the product module 120 may inspect local application data stored on the mobile computing device to determine one or more products to associate with a user of the mobile computing device. The method 1100 may continue at operation 1112 and the detection module 140 may detect a short wavelength wireless signal 660 from a beacon 604 for a merchant 620, and may determine that the mobile computing device is within a threshold range of the merchant 620.

The method 1100 may continue at operation 1114 and the advertisement module 160 may receive one or more advertisements describing products that are available at the merchant 620. The method 1100 may continue at operation 1116 and the advertisement module 160 may present the selected advertisement.

In one example embodiment of the method 1100, the transaction module 220 may inquire whether the user desires to purchase an advertised product. Based on an affirmative response, the advertisement module 220 may, at operation 1118, transmit a purchase request for the advertised product to the merchant 620. In another example embodiment, the purchase request may include a photograph of the user to allow the merchant 620 to verify the identity of the user.

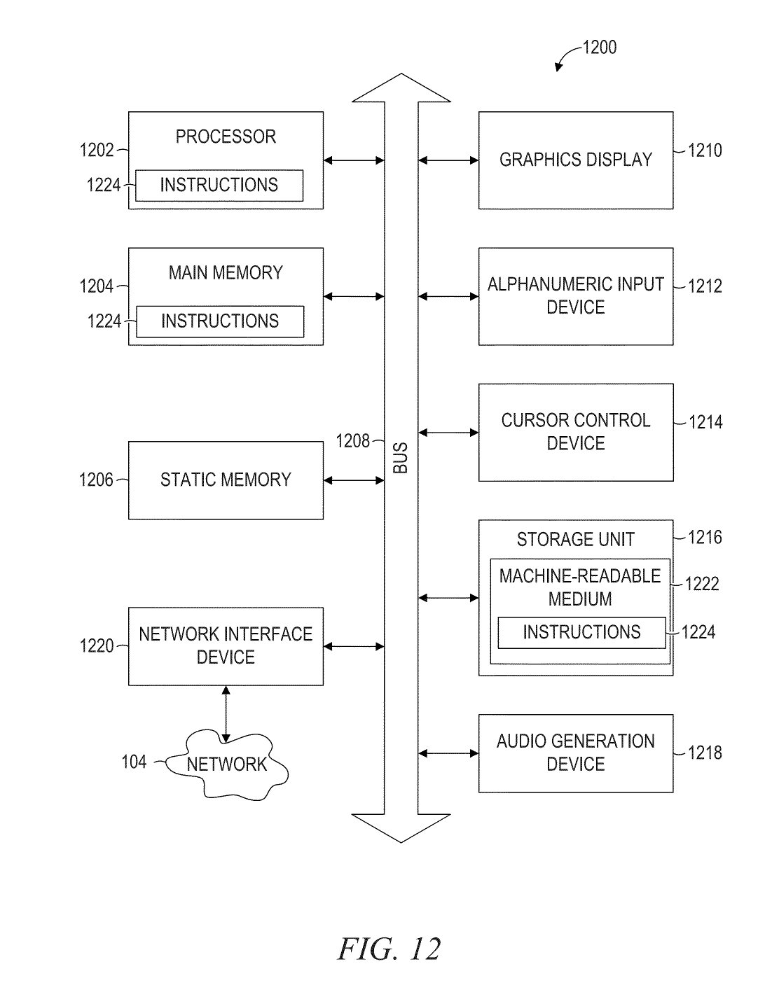

FIG. 12 is a block diagram illustrating components of a machine 1200, according to some example embodiments, able to read instructions 1224 from a machine-readable medium 1222 (e.g., any of a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part. In one example embodiment, the product module 120, the detection module 140, and the advertisement module 160 may be included in the instructions 1224.

In alternative embodiments, the machine 1200 may operate as a standalone device or may be connected (e.g., networked) to other machines. The product module 120, the detection module 140 and the advertisement module 160 may operate via the machine 1200. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein. Therefore, in certain embodiments, the various modules described herein may be executed on different machines operating as part of the system 100.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

In one example, the product module 120 may be operated by the processor 1202, and the product module 120 may inspect the main memory 1204, the static memory 1206 for application data. In another example, the product module 120 and the advertisement module 160 may communicate with beacons, merchants, remote devices, or the like using the network interface device 1220.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The advertisement module 160 may present a received advertisement via the display 1210. The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220. In certain embodiments, the product module 120 and the advertisement module 140 may communicate with a remote device via the network interface device 1220.

The storage unit 1216 includes the machine-readable medium 1222 on which are stored the instructions 1224 embodying any one or more of the methodologies or functions described herein. The storage unit 1216 may store application data for applications executing on the machine 1200. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 104 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components (e.g., sensors or gauges) (not shown). In one example, the machine includes a wireless transmitter for transmitting a short wavelength wireless signal as described herein. Other examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non exclusive “or,” unless specifically stated otherwise.

What is claimed is:

1. A computer system comprising:
a processor;
a memory device holding an instruction set executable on the processor to cause the mobile computer system to perform operations comprising:
receiving, from a mobile computing device and based on application data stored at the mobile computing device, one or more products associated with a user of the mobile computing device;
detecting the mobile computing device within a threshold range of a merchant based on a short-wavelength wireless signal from the mobile computing device;
transmitting an advertisement to the mobile computing device for one or more of the products available at the merchant.

2. The computer system of claim 1, wherein the operations further comprise receiving, from the mobile device, a request to purchase a product described in the advertisement and performing a financial transaction for the product.

3. The computer system of claim 2, wherein the request to purchase the product further comprises a photograph of the user.

4. The computer system of claim 1, wherein one of the products is further based on the location of the mobile computing device.

5. The computer system of claim 1, wherein one of the products is a product related to a product identified based on the application data.

6. The computer system of claim 1, wherein the advertisement comprises media content selected from the group consisting of text, audio, an image, and video.

7. The computer system of claim 1, wherein the operations further comprise detecting a plurality of mobile devices within the threshold range, determining a class of users of the plurality of mobile computing devices, requesting an advertisement for the class of users from the merchant.

8. A computer-implemented method comprising:
receiving, from a mobile computing device and based on application data stored at a mobile computing device, one or more products associated with a user of the mobile computing device;
detecting the mobile computing device within a threshold range of a merchant based on a short-wavelength wireless signal from the mobile computing device;
transmitting an advertisement to the mobile computing device for one or more of the products available at the merchant.

9. The computer-implemented method of claim 8, further comprising receiving a request to purchase an advertised product and performing a financial transaction for the advertised product.

10. The computer-implemented method of claim 9, wherein the request to purchase the advertised product further comprises a photograph of the user.

11. The computer-implemented method of claim 8, wherein the one or more products is further based on the location of the mobile computing device.

12. The computer-implemented method of claim 8, wherein one of the products is a product related to a product identified based on the application data.

13. The computer-implemented method of claim 8, wherein the advertisement comprises media content selected from the group consisting of text, audio, an image, and video.

14. The computer-implemented method of claim 8, further comprising detecting a plurality of mobile devices within the threshold range, determining a class of users of the plurality of mobile computing devices, and requesting an advertisement from the merchant for the class of users.

15. A machine-readable medium storing executable instructions thereon, which, when executed by a processor, cause the processor to perform operations including:
inspecting local data stored on the mobile computer system to determine one or more products associated with a user of the computer system;
determining a location of the mobile computer system based on a short-wavelength wireless signal received from a beacon for a merchant;
receiving one or more advertisements describing products available from the merchant;
selecting one of the advertisements based on the advertisement describing one of the associated products; and
presenting the selected advertisement to the user.

16. The machine-readable medium of claim 15, wherein the operations further comprise transmitting a request to purchase the associated product described in the advertisement.

17. The machine-readable medium of claim 15, wherein the request to purchase the product further comprises a photograph of the user.

18. The machine-readable medium of claim 15, wherein the one or more products is further based on the location of the mobile computing device.

19. The machine-readable medium of claim 15, wherein one of the relevant products is a product related to a product identified in the application data.

20. The machine-readable medium of claim 15, wherein the advertisement comprises media content selected from the group consisting of text, audio, an image, and video.
